(19) United States
(12) Patent Application Publication
(10) Pub. No.: US 2015/0208427 A1
(43) Pub. Date: Jul. 23, 2015

(54) RECEIVER AND RECEIVING METHOD

(71) Applicant: FUJITSU LIMITED, Kawasaki-shi (JP)

(72) Inventors: Hideki FURUDATE, Ota (JP); Minoru OKADA, Ikoma (JP); Ziji MA, Ikoma (JP); Tomonori SATO, Ikoma (JP)

(21) Appl. No.: 14/578,263

(22) Filed: Dec. 19, 2014

(30) Foreign Application Priority Data
Jan. 17, 2014 (JP) 2014-006330

(51) Int. Cl. H04W 72/08; H04L 29/06; H04L 5/00

(52) U.S. Cl. CPC H04W 72/082; H04L 5/0048; H04L 69/22

(57) ABSTRACT

A receiver includes: an extraction unit configured to extract a pilot signal of a received symbol including the pilot signal and a data signal, the symbol being one of sequential symbols received by the receiver; an estimation unit configured to calculate a channel estimation value indicating an estimation result of a channel impulse response in the symbol, based on the pilot signal by executing a decoding algorithm of compressed sensing; a reduction unit configured to perform a predetermined operation on each of channel estimation values of symbols of a predetermined number among the symbols, the operation reducing an error component included in the channel estimation value; and a canceller unit configured to cancel an inter-carrier interference component included in any one of symbols of the predetermined number, based on the channel estimation value in which the error component is reduced.

### CROSS-REFERENCE TO RELATED APPLICATION

This application is based upon and claims the benefit of priority of the prior Japanese Patent Application No. 2014-006330, filed on Jan. 17, 2014, the entire contents of which are incorporated herein by reference.

### FIELD

The embodiments discussed herein are related to a receiver and a receiving method.

### BACKGROUND

Terrestrial digital television broadcasting, a wireless local area network (WLAN), and the like use an orthogonal frequency division multiplex (OFDM) method to avoid an influence of waveform distortion due to multipath propagation. In the OFDM method, a transmission bandwidth is divided into multiple narrow band signals and the divided narrow band signals are transmitted in parallel. In this way, the OFDM method enables wide band transmission while avoiding the influence of waveform distortion due to the multipath propagation.

The OFDM method uses a phase shift keying (PSK) or a quadrature amplitude modulation (QAM) as a modulation method for narrow band signals. In this case, the amplitudes and phases of narrow band signals vary depending on a multipath channel. For this reason, to perform demodulation of PSK or QAM, a frequency response or an impulse response of a channel (also referred to as a propagation path) has to be estimated. In other words, the channel has to be estimated.

To estimate a channel, known signals are inserted as pilot signals into part of OFDM transmission signals. A receiver extracts the pilot signals and estimates amounts of amplitude and phase variation received by the pilot signals due to the channel. The receiver performs interpolation processing on the estimated amplitude and phase variation amounts of the pilot signals to estimate a frequency response characteristic. However, due to influences of multipath, fading, and noise, there is a case where the channel is incapable of being estimated with high accuracy.

And now, the propagation path of the multipath channel includes a finite number of paths. With this configuration, an impulse response has an impulse in a delay temporal position of each path and 0 in almost all other delay time. For the case where targets to be estimated are 0 in almost all positions (for example, temporal positions) and only partial positions have a value other than 0 as mentioned above, in other words, the targets have sparsity, a method called compressed sensing of estimating the targets with high accuracy has been recently proposed. These techniques have been described in: Japanese Laid-open Patent Publication Nos. 2011-146813, 2011-228890, and 2004-208254; Non-patent document 1, D. L. Donoho, “Compressed Sensing”, Information Theory, IEEE Transactions on, 52(4); 1289-1306, April 2006; Non-patent document 2, E. J. Candes, J. Romberg, and T. Tao, “Robust Uncertainty Principles: Exact Signal Reconstruction From Highly Incomplete Frequency Information”, Information Theory, IEEE Transactions on, 52(2); 489-509, February 2006; Non-patent document 3, E. J. Candes, “The restricted isometry property and its implications for compressed sensing”, Comptes Redus Mathematique, 346(5); 589-592, May2008; and Non-patent document 4, W. U. Bajwa, J. Haupt. A. M. Sayeed, and R. Nowak, “Compressed Channel Sensing: A New Approach to Estimating Sparse Multipath Channels”, Proceedings of the IEEE, 98(6):1058-1076, June 2010.

### SUMMARY

According to an aspect of the invention, a receiver includes: an extraction unit configured to extract a pilot signal of a received symbol including the pilot signal and a data signal, the symbol being one of sequential symbols received by the receiver; an estimation unit configured to calculate a channel estimation value indicating an estimation result of a channel impulse response in the symbol, based on the pilot signal by executing a decoding algorithm of compressed sensing; a reduction unit configured to perform a predetermined operation on each of channel estimation values of symbols of a predetermined number among the symbols, the operation reducing an error component included in the channel estimation value; and a canceller unit configured to cancel an inter-carrier interference component included in any one of symbols of the predetermined number, based on the channel estimation value in which the error component is reduced.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example block diagram illustrating the hardware configuration of a receiver according to a first embodiment;

FIG. 2 is a diagram schematically illustrating a state where CS processing is executed on sequential symbols which are outputted by a first FFT unit 14 in FIG. 1;

FIGS. 3A and 3B are graphs for briefly illustrating an l₁ recovery method;

FIG. 4 is an example block diagram illustrating the hardware configuration of an ICI replica creation unit 18 and an ICI canceller unit 19 which are described in FIG. 1;

FIG. 5 is an example block diagram illustrating the hardware configuration of a receiver according to a second embodiment;

FIGS. 6A to 6C are diagrams, each illustrating how to calculate a time variation amount of a channel estimation value described in FIG. 5;

FIG. 7 is a graph schematically illustrating changes of E²(n, f) in some pilot subcarrier nₖ;

FIGS. 8A to 8C are graphs, each illustrating processing of calculating an Fd estimation value based on a delay profile;

FIG. 9 is an example block diagram illustrating the hardware configuration of a receiver according to a third embodiment;

FIG. 10 is a graph illustrating a delay profile;

FIG. 11 is a diagram schematically illustrating a provisional sensing matrix Xₜ; and

FIG. 12 is a graph illustrating a delay profile obtained by executing an OMP method on a power component of an impulse response illustrated in FIG. 10.

### DESCRIPTION OF EMBODIMENTS

Use of a compressed sensing channel estimation method enables channel estimation with higher accuracy than a conventional channel estimation method which was used before the compressed sensing channel estimation method was proposed. However, if phasing occurs due to movement of a receiver, an inter-carrier interference (ICI) occurs. The receiver cancels the inter-carrier interference component (hereinafter, referred to as an inter-carrier interference or ICI) by using an estimated channel frequency response or impulse response. However, if the channel is not estimated with high accuracy, it is difficult to cancel the inter-carrier interference with high accuracy.

Hereinafter, embodiments of a receiver and a receiving method in which a channel may be estimated with high accuracy are described by referring the drawings.

### First Embodiment

### A Block Diagram of a Receiver According to a First Embodiment

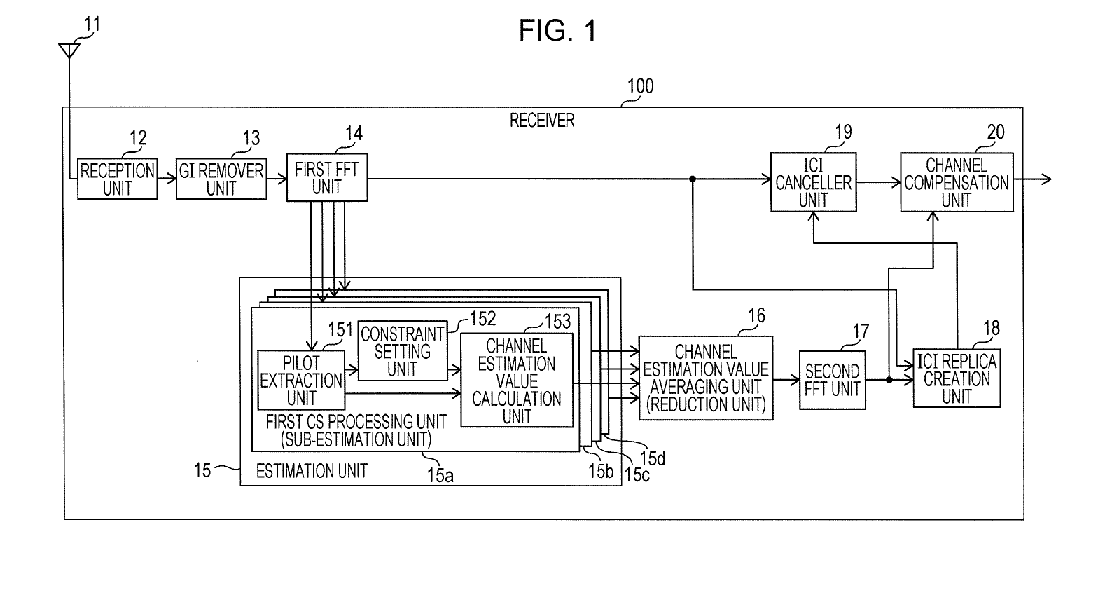

FIG. 1 is an example block diagram illustrating the hardware configuration of a receiver according to a first embodiment. A receiver 100 includes a reception unit 12, a GI remover unit 13, a first FFT unit 14, and an estimation unit 15. Here, GI stands for a guard interval. Furthermore, the receiver 100 has a channel estimation value averaging unit (reduction unit) 16, a second FFT unit 17, an ICI replica creation unit 18, an ICI cancel unit 19, and a channel compensation unit 20. Hereinafter, the channel estimation value averaging unit (reduction unit) is referred to as a channel estimation value averaging unit.

The reception unit 12 receives, via an antenna 11, an OFDM radio signal, for example, which is transmitted from an unillustrated transmitter. The reception unit 12 executes down convert processing, quadrature demodulation processing, and the like on the received signal to create a reception signal. Furthermore, the reception unit 12 converts the reception signal into a digital signal and outputs the converted signal to the GI remover unit 13. The OFDM radio signal is a symbol (also called as a frame) including a pilot signal (also called as a known signal) and a data signal, for example. The reception unit 12 receives this symbol.

The GI remover unit 13 removes a GI from the digital signal outputted from the reception unit 12 and outputs the digital signal whose GI is removed to the first FFT unit 14.

The first FFT unit 14 executes fast Fourier transform processing on the effective symbol whose GI is removed and converts the digital signal in a time domain to the digital signal in a frequency domain. The fast Fourier transform is expressed as FFT as appropriate. The first FFT unit 14 outputs the digital signal in the frequency domain to the estimation unit 15, the ICI replica creation unit 18, and the ICI canceller unit 19. The first FFT unit 14 executes FFT processing on each of sequential symbols (for example, four symbols) and outputs the digital signal in the frequency domain in each symbol to each of first CS processing unit (sub-estimation unit) 15a to fourth CS processing unit (sub-estimation unit) 15d. Hereinafter, the CS (cyclic shifts) processing unit (sub-estimation unit) is expressed as CS processing unit.

The estimation unit 15 executes a decoding algorism of the compressed sensing and calculates a channel estimation value indicating an estimation result of an impulse response of a channel in the symbol.

The estimation unit 15 has multiple CS processing units, for example, first CS processing unit 15a to fourth CS processing unit 15d, to calculate a channel estimation value. Each of the CS processing units calculates each channel estimation value of each of the sequential symbols.

The first CS processing unit 15a to the fourth CS processing unit 15d output the calculated channel estimation values to the channel estimation value averaging unit 16. The channel estimation values which are outputted by the first CS processing unit 15a to the fourth CS processing unit 15d are the channel estimation values in the time domain. Here, the number of the CS processing units in FIG. 1 is four, but the number is an example.

Each of the first CS processing unit 15a to the fourth CS processing unit 15d has a pilot extraction unit 151, a constraint setting unit 152, and a channel estimation value calculation unit 153.

The pilot extraction unit 151 extracts a pilot signal of the symbol. Specifically, the pilot extraction unit 151 extracts a pilot signal of the symbol including a pilot signal and a data signal from the digital signal in the frequency domain outputted from the first FFT unit 14. More specifically, the pilot extraction unit 151 extracts a pilot signal from the digital signal on which the FFT processing is executed and outputs the extract pilot signal to the constraint setting unit 152 and the channel estimation value calculation unit 153.

The constraint setting unit 152 sets a constraint which is referred in the channel estimation value calculation unit 153 to the channel estimation value calculation unit 153. The constraint is a restricted isometry property (RIP) described in Non-patent document 3. As for the constraint, in particular, refer to Formula 3 in Non-patent document 3.

The channel estimation value calculation unit 153 executes a compressed sensing decoding algorism and calculates a channel estimation value in the symbol based on the pilot signal. The compressed sensing decoding algorism is an l₁ recovery method (also referred as a basis pursuit method) using a restricted isometry property, for example. The channel estimation value calculation unit 153 uses the l₁ recovery method to create a channel estimation value in the time domain from the pilot signal in the frequency domain outputted by the pilot extraction unit 151. This is described in detail later.

As described above, in the estimation unit 15, the multiple CS processing units each configured to calculate the channel estimation value are provided in parallel and calculate the channel estimation values in the sequential symbols at the same time. As a result, time for the channel estimation value averaging unit 16 to calculate an average value of the channel estimation values may be shortened. Incidentally, the estimation unit 15 may include one CS processing estimation unit.

The channel estimation value averaging unit 16 performs a predetermined operation to reduce an error component (hereinafter, it may be expressed as an error) included in the channel estimation value on the respective channel estimation values of the predetermined number of symbols. This example predetermined operation is an averaging operation (for example, an arithmetic mean) of the predetermined number of the channel estimation values. Specifically, the channel estimation value averaging unit 16 calculates an average value of the channel estimation values by averaging the predetermined number of the channel estimation values among the channel estimation values in the time domain which are outputted from the first CS processing unit 15a to the fourth CS processing unit 15d, and outputs it to the second FFT unit 17. Besides, as the predetermined operation, a weighted average of the predetermined number of the channel estimation values may be calculated. This averaged channel estimation value is a channel estimation value in which the error component is reduced.

The second FFT unit 17 executes FFT processing on the averaged channel estimation value (in the time domain) outputted from the channel estimation value averaging unit 16 and creates a channel estimation value in the frequency domain, and then outputs to the ICI replica creation unit 18 and the channel compensation unit 20. Hereinafter, the channel estimation value which is averaged is expressed as an averaged channel estimation value as appropriate.

Based on the digital signal in the frequency domain outputted from the first FFT unit 14 and the channel estimation value in the frequency domain outputted from the second FFT unit 17, the ICI replica creation unit 18 creates an ICI replica which is data for cancelling ICI and outputs it to the ICI canceller unit 19.

Based on the channel estimation value averaged by the channel estimation value averaging unit 16, the ICI canceller unit 19 cancels the inter-carrier interference included in the data signal in any one of the predetermined number of the symbols.

Specifically, the ICI canceller unit 19 cancels ICI from the digital signal in the frequency domain which is outputted from the first FFT unit 14 by using an ICI replica which is outputted from the ICI replica creation unit 18 and outputs it to the channel compensation unit 20.

The channel compensation unit 20 refers to the channel estimation value in the frequency domain which is outputted by the second FFT unit 17 to estimate a channel characteristic of the data signal in the digital signal in the frequency domain whose ICI is cancelled. Then, the channel compensation unit 20 executes compensation processing to remove the channel characteristic from the data signal based on the estimated channel characteristic and outputs the data signal to the upper application (unillustrated).

(CS Processing)

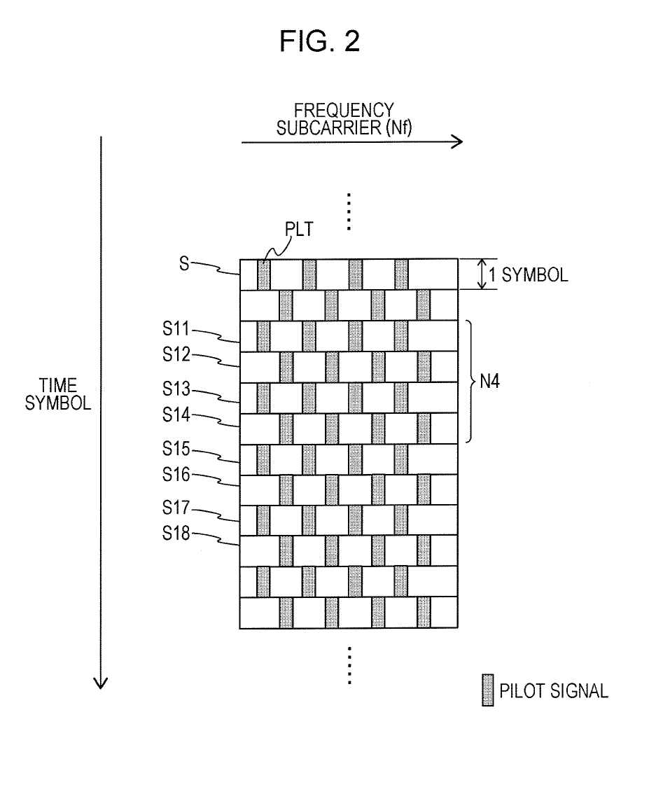

FIG. 2 is a diagram schematically illustrating a state where CS processing is executed on sequential symbols which are outputted by the first FFT unit 14 in FIG. 1. In FIG. 2, a landscape-oriented rectangular frame depicted by reference character S indicates one symbol. Then, a vertically-long rectangular frame (see a dotted area) depicted by reference character PLT indicates a pilot signal.

An outline portion in each symbol indicates a data signal. A downward arrow in the figure indicates an elapsed time. FIG. 2 illustrates a state where the first FFT unit 14 sequentially outputs sequential symbols on which the FFT is performed. A rightward arrow from the left in the drawing indicates a frequency subcarrier in each symbol.

In the first CS processing unit 15a to the fourth CS processing unit 15d, pilot signals (also referred to as pilot subcarriers) which are disposed in a predetermined subcarrier domain in one symbol are extracted by the pilot extraction unit 151, and the channel estimation value calculation unit 153 calculates a channel estimation value from this pilot signal.

The first FFT unit 14 outputs the L-th symbol from the beginning on which the FFT processing is executed to the first CS processing unit 15a, and outputs the (L+1)th symbol on which the FFT processing is executed to the second CS processing unit 15b. The first FFT unit 14 outputs the (L+2)th on which the FFT processing is executed to the third CS processing unit 15c and outputs the (L+3)th symbol on which the FFT processing is performed to the fourth CS processing unit 15d. These L-th to (L+3)th symbols are sequential symbols and four symbols depicted by reference numeral N4, for example. Here, L is a multiple of 4, such as 0, 4, 8 . . . , and is counted up for every multiples of 4. When the number of the CS processing units is N (an integer of 2 or larger), L is a multiple of N including 0.

For example, the first FFT unit 14 outputs a symbol S11 on which the FFT processing is executed to the first CS processing unit 15a, and outputs a symbol S12 on which the FFT processing is executed to the second CS processing unit 15b. Furthermore, the first FFT unit 14 outputs a symbol S13 on which the FFT processing is executed to the third CS processing unit 15c, and outputs a symbol S14 on which the FFT processing is executed to the fourth CS processing unit 15d.

Then, the first FFT unit 14 outputs a symbol S15 on which the FFT processing is executed to the first CS processing unit 15a, and outputs a symbol S16 on which the FFT processing is executed to the second CS processing unit 15b. Furthermore, the first FFT unit 14 outputs a symbol S17 on which the FFT processing is executed to the third CS processing unit 15c and outputs a symbol S18 on which FFT processing is executed to the fourth CS processing unit 15d.

As described above, the first FFT processing unit 14 respectively outputs the four sequential symbols on which the FFT processing is executed to the first CS processing unit 15a to the fourth CS processing unit 15d. After that, the first FFT unit 14 outputs four sequential symbols, following those four sequential symbols, on which FFT processing is executed to the first CS processing unit 15a to the fourth CS processing unit 15d.

The first CS processing unit 15a to the fourth CS processing unit 15d calculate a channel estimation value with regard to the symbols outputted from the first FFT unit 14. Specifically, the first CS processing unit 15a calculates a channel estimation value for the L-th symbol, and the second CS processing unit 15b calculates a channel estimation value for the (L+1)th symbol. The third CS processing unit 15c calculates a channel estimation value for the (L+2)th symbol, and the fourth CS processing unit 15d calculates a channel estimation value for the (L+3)th symbol.

In the above described examples, the first CS processing unit 15a calculates a channel estimation value for the symbol S11, and the second CS processing unit 15b calculates a channel estimation value for the symbol S12 following the symbol S11. The third CS processing unit 15c calculates a channel estimation value for the symbol S13 after the symbol S12, and the fourth CS processing unit 15d calculates a channel estimation value for the symbol S14 following the symbol S13. Similarly, the first CS processing unit 15a to the fourth CS processing unit 15d also estimate channel estimation values for symbols after the symbol S15. In this manner, processing of calculating channel estimation values by sliding symbols one by one is also referred to as sliding CS processing.

Here, the estimation unit 15 may have one CS processing unit. In this case, the first FFT unit 14 performs FFT processing on one symbol and outputs the proceeding result to the estimation unit 15. The estimation unit 15 calculates a channel estimation value in a symbol on which the FFT processing is performed and outputs it to the channel estimation value averaging unit 16. The channel estimation value averaging unit 16 records the outputted channel estimation values in a memory (unillustrated) and calculates an average of these values at the timing when the predetermined number of the channel estimation values is recorded in the memory.

(Estimation of an Impulse Response of a Multipath Channel)

Here, the description is given to an approach to estimate an impulse response of a multipath channel (calculate a channel estimation value), which uses the compressed sensing. For example, Non-patent document 1 proposed an approach to estimate a vector having sparsity from an observation vector. This approach is to estimate a vector by searching a vector in which the sum of absolute values of elements becomes the smallest. In this approach, a widely known linear programming may be used.

The l₁ recovery method of the compressed sensing estimates an impulse response of a multipath channel by using the linear programming. As an approach to estimate an impulse response of a multipath channel by using this technique, the Non-patent document 4 proposes a technique which uses the compressed sensing as a channel estimation technique in an OFDM or frequency spreading method and discloses that impulse response estimation accuracy is improved.

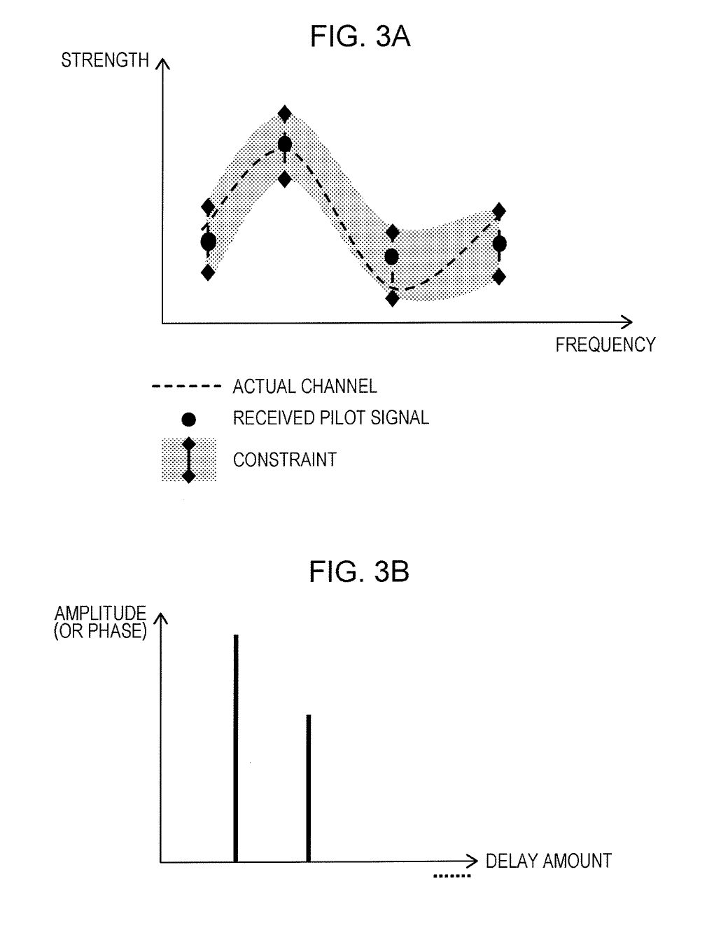

Hereinafter, the l₁ recovery method is briefly described. FIGS. 3A to 3C are graphs for briefly illustrating the l₁ recovery method.

FIG. 3A is a graph schematically illustrates channel variations in the frequency domain. The horizontal axis schematically indicates a frequency and the vertical axis schematically indicates power (amplitude) of each frequency. In FIGS. 3A to 3C, black circles schematically indicate pilot signals and the broken line indicates strength in an actual channel. The portion hatched by the dotted lines schematically indicates constraints described in FIG. 1.

FIG. 3B is a graph schematically illustrating dispersion of the impulse responses of the multipath channel on the time axis, which is estimated by the l₁ recovery method. The graph of FIG. 3B is also referred to as a delay profile. The horizontal axis is a delay amount (time) and the vertical axis is power (amplitude) of an impulse response.

The power of the impulse response of a dominant wave exists in the position where the delay amount (delay time) is 0.

Assuming that a vector of a transmission signal is x, a vector of a reception signal is y, a transformation matrix of a channel is A, the following equation holds.

y=Ax (Formula 1)

In Formula 1, x is an M dimensional transmission signal vector. The transformation matrix A in the above formula is a matrix including N rows and M columns of elements. In this case, y in Formula 1 is an N dimensional reception signal vector. Here, a vector y of the reception signal is equivalent to a pilot signal in a frequency domain, which is outputted by the pilot extraction unit 151. Also, a vector x of the transmission signal is equivalent to the transmission signal which is transmitted from a transmitter (unillustrated) to the receiver 100. Then, M is equivalent to the number of OFDM carriers.

When the transformation matrix A is regarded as a channel, the column components of the transformation matrix A indicate a state of the multipath. Accordingly, when the number of multipath K is sufficiently smaller than the M columns and has sparsity (if sparse), in other words, in the case of K<<M, the transmission signal vector x may be recovered by using the l₁ recovery method of the compressed sensing. The equation of the l₁ recovery method is given below as Formula 2.

$$\hat{x} = arg {min}_{x} {‖ x ‖}_{1} \\ subject to y = Ax \qquad ( Formula 2 )$$

In Formula 2, under the condition that a constraint condition y=Ax is met, calculated is an estimation vector \hat{x} of the transmission signal vector x which minimizes an absolute value sum (L1 norm) of the transmission signal vector x. This constraint condition is a condition in which a value obtained by multiplication of the transmission signal vector x by the transformation matrix A becomes equal to the reception signal vector y.

In the estimation vector calculation process, the column component of the transformation matrix A is calculated. The channel estimation value calculation unit 153 calculates a channel estimation value of a channel based on the calculated column component of the transformation matrix A.

The Formula 2 may be changed to a linear programming problem as expressed by following Formula 4 by using an auxiliary vector t whose size is same with that of the transmission signal vector x. Here, the auxiliary vector t is the M dimensional vector as expressed by following Formula 3.

$$\begin{matrix}t = {( {t}_{1} , {t}_{2} … , {t}_{M} )}^{T} & ( Formula 3 ) \\ \hat{x} = arg {min}_{τ} {\sum }_{i = i}^{N} {t}_{i} \\ subject to \\ - t \leq x \leq t , y = Ax & ( Formula 4 )\end{matrix}$$

In Formula 4, −t≦x≦t,y=Ax is used as the constraint condition to calculate an estimation vector of the transmission signal vector x, which minimizes the total sum of the absolute values of coefficient of the auxiliary vector t.

Formula 4 may be solved by a general linear programming method. In the process of solving Formula 4, column components of the transformation matrix A indicating the state of the multipath may be obtained. This column component is relevant to the channel estimation value.

The channel estimation value calculation unit 153 uses Formula 4 to estimate an impulse response of the multipath channel, in other words, to calculate a channel estimation value.

(Averaging of Channel Estimation Values)

Next, the channel estimation value averaging unit 16 of FIG. 1 is described. It is assumed here that a channel estimation value at time t in l(L in a small letter)th symbol is set to h̅′(t). This l is an integer. Each of the first CS processing unit 15a to the fourth CS processing unit 15d outputs, for example, h′(t), h¹⁺¹(t), h¹⁺²(t), h¹⁺³(t) to the channel estimation value averaging unit 16. This time t indicates timing of setting (also referred to as cutting out) an FFT window.

The channel estimation value averaging unit 16 averages the channel estimation values of these symbols in the predetermined number of the symbols (for example, 4) based on following Formula 5. This predetermined number is the number of target symbols to be averaged. Specifically, the channel estimation value averaging unit 16 calculates a total sum of the channel estimation values of a first symbol which is any one of the predetermined number of symbols (hereinafter, expressed as a target symbol), of one or more second symbols whose temporal positions are before the target symbol, and one or more third symbols whose temporal positions are after the target symbol.

The channel estimation value h̅′(t) of the target symbol after the averaging is calculated by the calculus equation expressed by following Formula 5 when it is assumed that a predetermined number is Nt (Nt is, for example, an even number).

$${\overline{h}}^{′} ( t ) = \frac{1}{Nt} {\sum }_{k = l - Nt / 2}^{l + Nt / 2 - 1} {h}^{k} ( t ) \qquad ( Formula 5 )$$

For example, in FIG. 2, when l is 6 (for example, the 6th symbol equivalent to the target symbol S14) and Nt is 4, the second symbol is the 4th symbol S12 and the 5th symbol S13. Then, the third symbol is the 7th symbol S15.

According to Formula 5, the average value of the channel estimation values of the target symbol S14 is calculated as ((h⁴(t)+h⁵(t)+h⁶(t)+h⁷(t)/4). The channel estimation value averaging unit 16 executes Formula 5 to average the channel estimation values, and outputs an average value of the channel estimation values in the l-th symbol. In other words, the channel estimation value averaging unit 16 counts up l-th symbol from 0 one by one and outputs the average value of the channel estimation values in the l-th symbol. When l is less than Nt/2, the channel estimation value averaging unit 16 does not perform calculation processing of the average value of the channel evaluation values and outputs the channel estimation values which are not averaged to the second FFT unit 17 without averaging them.

Here, the reason for averaging the channel estimation values is described. There is an error between a calculated channel estimation value and a channel value obtained under an ideal condition (hereinafter, referred to as a correct channel estimation value). This error is an error component which is caused due to an influence of fading, noise, or the like.

In the case where this error component is an error with high randomness, the error component is reduced (also called cancelled) from the averaged channel estimation value when the channel estimation values are averaged. In other words, when the channel estimation values are averaged, the averaged channel estimation value becomes closer to a correct channel estimation value.

For this reason, the receiver 100 according to the present embodiment averages the multiple calculated channel estimation values and calculates an average value of the channel estimation values. With this averaging, the error component included in the channel estimation value is reduced.

Then, the ICI canceller unit 19 cancels ICI included the signal in the target symbol based on the averaged channel estimation value. To perform the cancellation, the receiver 100 calculates an ICI replica for cancelling ICI using the averaged estimation value.

(ICI Cancelation)

The ICI cancelation executed by the ICI canceller unit 19 is described. Since the receiver 100 moves during the period in which the receiver 100 is communicating with the transmitter, a so-called Doppler shift occurs. Here, this communication is an OFDM communication. When there is the Doppler shift, a frequency drift is caused in each subcarrier, and the reception signal of the first subcarrier receives an influence (also called interfered) from the reception signals of the adjacent second and third subcarriers. This influence is ICI. The ICI canceller unit 19 cancels this ICI.

The signal after ICI cancellation \tilde{Y}ₙ may be obtained by subtracting an ICI replica from the reception signal Yₙ of the subcarrier n as expressed by Formula 6. Here, the ICI replica is created by the ICI replica creation unit 18.

$${\tilde{Y}}_{n} = {Y}_{n} - {\sum }_{k = 0 , k = n}^{N - 1} I C {I}_{n , k} \qquad ( Formula 6 )$$

Here, ICI_{n,k} is the ICI from the reception signal of the adjacent subcarrier k with regard to the reception signal of the subcarrier n. Also, N is an FFT number of OFDM.

The ICI canceller unit 19 executes Formula 6 to cancel ICI from the reception signal Yₙ of the subcarrier n.

The ICI of the subcarrier n may be calculated by a product of three parameters as expressed by following Formula 7.

ICI_{n,k}− V̅′ₖ5ₖ₋ₙ\hat{X}ₖ (Formula 7)

Here, \hat{X}ₖ of Formula 7 is a replica of the transmission signal. And, V̅′ₙ of Formula 7 is a slope of the channel estimation value in the frequency domain.

The slope of the channel estimation value is calculated by dividing the channel variation amount by an elapsed time as expressed by following Formula 8.

$${\overline{V}}_{n}^{′ l} = \frac{{V}_{n}^{i + 1} - {V}_{n}^{l - 1}}{2 ( N + {N}_{Gl} )} \qquad ( Formula 8 )$$

In other words, the slope of the channel estimation value of the l-th symbol is obtained from the channel variation amount of the symbol before and after that symbol ((I−1)th symbol and (I+1)th symbol). Here, V′ₙ is the channel estimation value of the subcarrier n in the l-th symbol and N is an FFT number of OFDM, and N_{GI} is a GI length of OFDM. A weight V̅′_{Δn} of a carrier interval in Formula 7 is a value which is determined by the frequency with the subcarrier interval as expressed by Formula 9 with the weight of the subcarrier interval. Here, Δn is (k-n).

$${ϛ}_{Δ n} = - \frac{1}{1 - {e}^{j2πΔ n / N}} \\ ( Δ n mod N \neq 0 ) \qquad ( Formula 9 )$$

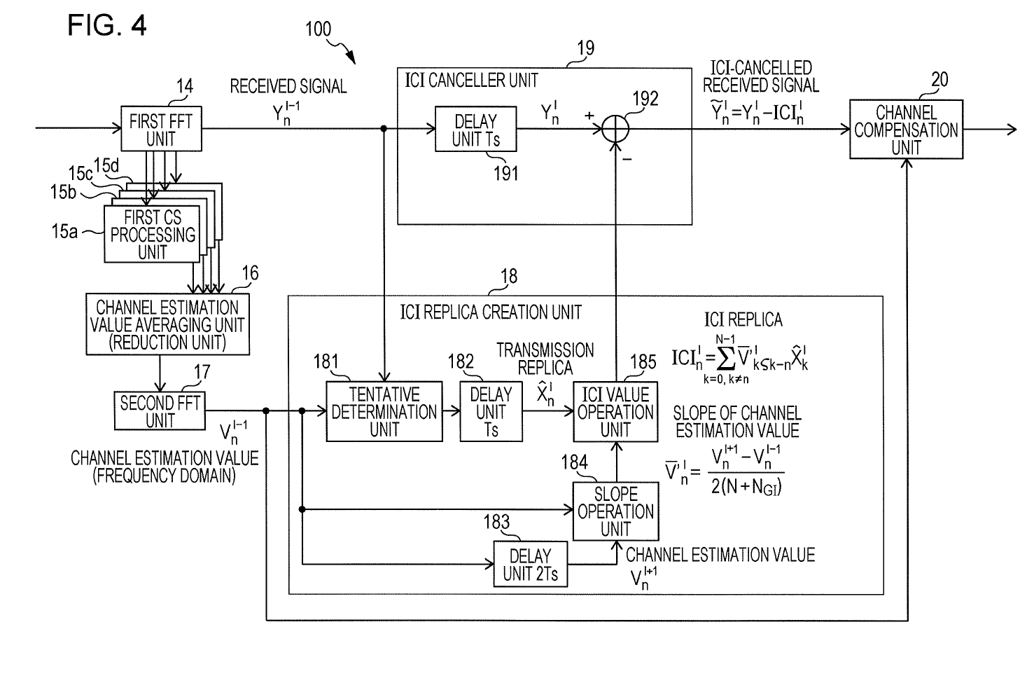

FIG. 4 is an example block diagram illustrating the hardware configuration of the ICI replica creation unit 18 and the ICI canceller unit 19 as illustrated in FIG. 1. The ICI replica creation unit 18 has a tentative determination unit 181, a delay unit Ts182, a delay unit 2Ts183, a slope operation unit 184, and an ICI value operation unit 185. The ICI canceller unit 19 has a delay unit Ts191 and a subtraction circuit 192.

The second FFT unit 17 outputs an averaged channel estimation value in the frequency domain to the tentative determination unit 181, the delay unit 2Ts183, the slope operation unit 184, and the channel compensation unit 20.

The averaged channel estimation value in the frequency domain in the subcarrier n in the (I−1)th symbol is Vₙ^{l-1}.

The tentative determination unit 181 calculates an ideal signal point of the subcarrier n in the reception signal (frequency domain) which is outputted by the first FFT unit 14 based on the averaged channel estimation value in the frequency domain, and outputs the calculated ideal signal point (also referred to as a transmission replica). Here, the calculation of the ideal signal point is also referred to as a tentative determination of the reception signal.

The tentative determination unit 181 outputs the calculated transmission replica to the delay unit Ts182. The delay unit Ts182 causes the outputted transmission replica to be delayed by one symbol and outputs it to the ICI value operation unit 185.

The transmission replica of the subcarrier n in the l-th symbol which is delayed by one symbol from the (l−1)th symbol is \hat{X}ₙ^{l}.

The delay unit 2Ts183 causes the averaged channel estimation value in the frequency domain which is outputted from the second FFT unit 17 to be delayed by 2 symbols and output it to the slope operation unit 184.

The averaged channel estimation value of the subcarrier n in the (l+1)th symbol which is delayed by 2 symbols from the (l−1)th symbol is Vₙ^{l+1}.

The slope operation unit 184 calculates a slope V̅^{vl}ₙ of the channel estimation value of the subcarrier n in the l-th symbol by substituting the channel estimation value which is inputted from the second FFT unit 17, the channel estimation value which is inputted from the delay unit 2Ts183, the FFT number of OFDM, and a GI length of OFDM into Formula 8, and outputs it to the ICI value operation unit 185.

The ICI value operation unit 185 calculates an ICI replica by substituting the transmission replica which is outputted by the delay unit Ts182, the slope of the channel estimation value which is outputted by the slope operation unit 184, and a weight of the carrier interval (expressed in Formula 7) into following Formula 10.

$$I C {I}_{n}^{i} = {\sum }_{k = 0 , k \neq n}^{N - 1} {\overline{V}}_{k}^{′ l} {ϛ}_{k - n} {\hat{X}}_{k}^{l} \qquad ( Formula 10 )$$

The delay unit Ts191 of the ICI canceller unit 19 causes the reception signal Yₙ^{l-1} of the subcarrier n in the (l−1)th symbol which is outputted by the first FFT unit 14 to be delayed by one symbol and outputs it to the subtraction circuit 192.

The reception signal of the subcarrier n in the l-th symbol, which is delayed by one symbol from the (l−1)th symbol, is Yₙ^{l}.

The subtraction circuit 192 subtracts the ICI replica which is outputted by the ICI value operation unit 185 from the reception signal which is outputted by the delay unit Ts191 and outputs the reception signal whose ICI is cancelled to the channel compensation unit 20. The reception signal whose ICI is cancelled is expressed by Formula 11.

\tilde{Y}ₙ^{l}=Yₙ^{l}−ICIₙ^{l} (Formula 11)

The channel compensation unit 20 performs channel compensation of the data signal in the l-th symbol based on the ICI-cancelled reception signal which is outputted by the subtraction circuit 192 and the channel estimation value which is outputted by the second FFT unit 17. The channel estimation value which is outputted by the second FFT unit 17 is delayed by one symbol, for example.

The receiver of the present embodiment averages the channel estimation values and reduces an error component of the channel estimation value. For this reason, a channel estimation value whose error component is reduced may be obtained and the inter-carrier interference may be cancelled by using the channel estimation value whose error component is reduced. As a result, high-accurate channel compensation becomes possible, so as to sufficiently improve the characteristic.

### Second Embodiment

As a receiver moves, a channel sometimes also varies. In particular, when a receiver 100 moves at high speed in the central area of a city, a channel may largely vary due to effects of structures such as buildings. As a result, a channel estimation value also largely varies. As described above, in a case where the channel largely varies, even though the number of channel estimation values to be averaging targets is increased and these channel estimation values are averaged, it is difficult to sufficiently cancel an error component with high randomness.

In other words, when the number of channel estimation values to be averaging targets is increased to effectively suppress an error with high randomness as described in the first embodiment under the situation in which variations of the channel are large, in contrast, a difference between an averaged channel estimation value and a correct channel estimation value becomes larger.

As described above, as the variation of the channel becomes larger, the difference between the averaged channel estimation value and the correct channel estimation value becomes larger. As a result, an accuracy of an ICI replica which is calculated to cancel the ICI becomes low and the ICI becomes impossible to be cancelled from the reception signal with high accuracy.

For this reason, according to the variation amount of channel, the number of channel estimation values to be averaging targets is changed. Specifically, as the variations of the channel become larger, the number of channel estimation values to be average targets is set to be smaller.

Here, the maximum Doppler frequency which has a positive correlation with a moving speed of the receiver 100 is associated with the variations of the channel. In other words, it is regarded that as the maximum Doppler frequency is larger, the variations of the channel are larger. On the other hand, it is regarded that as the maximum Doppler frequency is smaller, the variations of the channel is smaller.

### Block Diagram of the Receiver According to the Second Embodiment

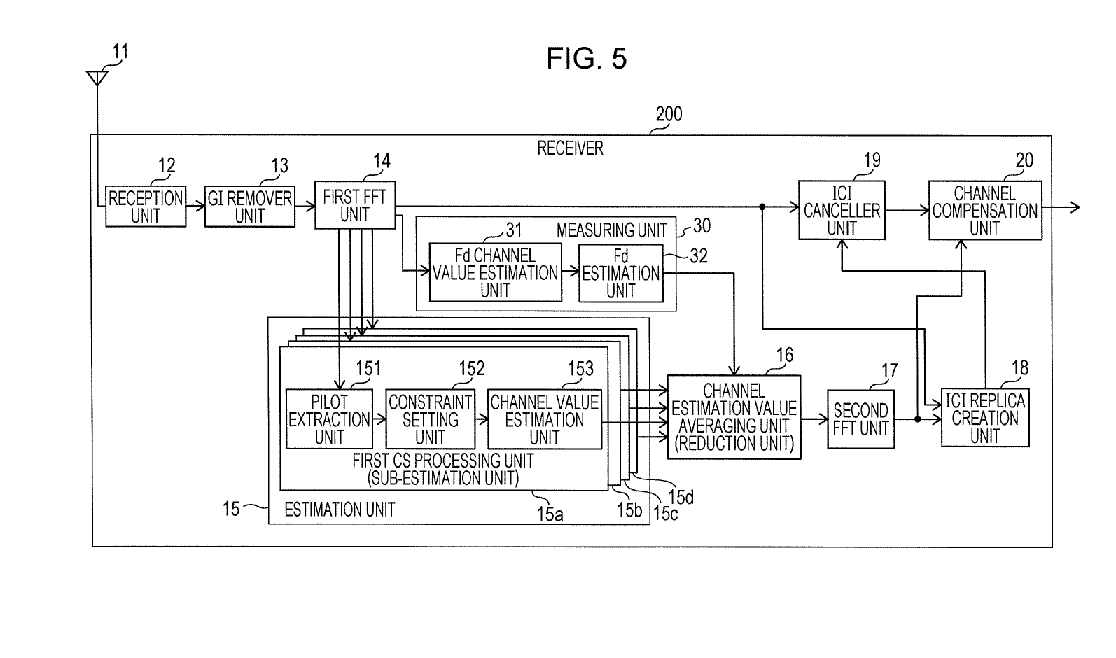

FIG. 5 is an example block diagram illustrating the hardware configuration of a receiver according to the second embodiment. A receiver 200 in the second embodiment has the configuration in which a measuring unit 30 is added to the receiver 100 described in the first embodiment. The measuring unit 30 measures variations of a channel. The measuring unit 30 has an Fd channel value estimation unit 31 and an Fd estimation unit 32. Here, Fd stands for the maximum Doppler frequency.

The FFT unit 14 outputs digital signals in a frequency domain to first CS processing unit 15a to fourth CS processing unit 15d, a channel compensation unit 20, and the measuring unit 30.

As illustrated in FIGS. 1 and 2, the Fd channel value estimation unit 31 extracts a pilot signal from a digital signal on which FFT processing is executed by a unit of symbol. The Fd channel value estimation unit 31 performs channel estimation based on the pilot signal in the frequency domain and calculates a channel estimation value. Here, this channel estimation value may be calculated by various channel estimation methods.

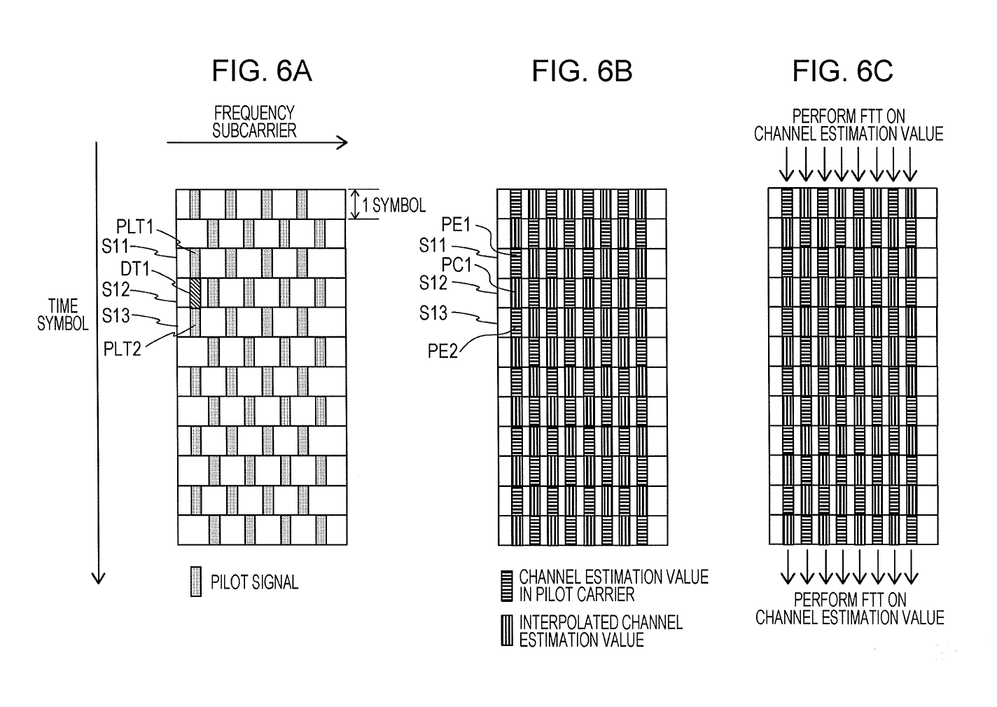

For example, the Fd channel value estimation unit 31 calculates a channel estimation value indicating a channel estimation result in each of the sequential symbols based on the pilot signal. Then, the Fd channel value estimation unit 31 measures the variation amount per unit time of the channel estimation value in each the calculated sequential symbols (hereinafter, referred to as a time variation amount) as a channel variation amount. For example, the Fd channel value estimation unit 31 executes FFT processing using a time symbol (time direction) as a reference on the calculated channel estimation value and calculates the time variation amount of the channel estimation value, and outputs it to the Fd estimation unit 32. Here, the Fd channel value estimation unit 31 is described in detail in FIGS. 6A to 6C.

Based on the time variation amount of the channel estimation value which is outputted by the Fd channel value estimation unit 31, the Fd estimation unit 32 estimates the maximum Doppler frequency and output it to the channel estimation value averaging unit 16. Hereinafter, the estimation result of the maximum Doppler frequency is expressed as an Fd estimation value as appropriate.

The channel estimation value averaging unit 16 sets the number (predetermined number) of channel estimation values to be averaging targets to be smaller as the channel variation amount becomes larger. In the above-described example, the channel estimation value averaging unit 16 sets the number of the channel estimation values to be averaging targets to be smaller in proportion to the Fd estimation value which is outputted by the Fd estimation unit 32.

For example, the channel estimation value averaging unit 16 determines the number Nc3 of the channel estimation values to be averaging targets when the Fd estimation value is less than Fd1. Also, the channel estimation value averaging unit 16 determines that the number of the channel estimation values to be averaging targets is Nc2 smaller than the number Nc3 when the Fd estimation value is equal to or more than Fd1 and less than Fd2 (Fd2 is larger than Fd1). In addition, the channel estimation value averaging unit 16 determines that the number of the channel estimation values to be averaging targets is Nc1 smaller than the number Nc2 when the Fd estimation value is equal to or more than Fd2. The channel estimation value averaging unit 16 averages the channel estimation values of the determined numbers. These determined numbers is Nt described in the first embodiment.

(A Time Variation Amount of the Channel Estimation Value)

FIGS. 6A to 6C are diagrams, each illustrating calculation of a time variation amount of a channel estimation value described in FIG. 5. Then, an outline portion in each symbol indicates a data signal. A downward arrow in the figure indicates an elapsed time. An arrow from the left to the right in the figure indicates a frequency subcarrier in each symbol.

FIG. 6A illustrates a state in which the first FFT unit 14 sequentially outputs the symbols on which FFT is performed, which is described in FIG. 2. Reference numeral PLT1 indicates a pilot signal allocated in the predetermined subcarrier frequency bandwidth (hereinafter, it is expressed as subcarrier bandwidth as appropriate) in the symbol S11. Reference numeral PLT2 indicates a pilot signal allocated in a subcarrier bandwidth same as the predetermined subcarrier bandwidth in the symbol S13. Reference numeral DT1 indicates a data signal allocated in a subcarrier bandwidth same as the predetermined subcarrier bandwidth.

The Fd channel value estimation unit 31 extracts the pilot signal (see FIG. 6A) allocated in the predetermined subcarrier in one symbol. The Fd channel value estimation unit 31 performs channel estimation based on the extracted pilot signal and calculates a channel estimation value corresponding to the subcarrier bandwidth in which the pilot signal is allocated.

The channel estimation value corresponding to the subcarrier bandwidth in which the extracted pilot signal is allocated is illustrated by a vertically long rectangular frame (see horizontal line hatching) illustrated in FIG. 6B.

In the examples of FIGS. 6A and 6B, based on the subcarrier signal PLT1 (see FIG. 6A) of the symbol S11, the Fd channel estimation value estimation unit 31 calculates a channel estimation value PE1 (see FIG. 6B) corresponding to the subcarrier bandwidth in which this subcarrier signal PLT1 is allocated. Based on the subcarrier signal PLT2 (see FIG. 6A) of the symbol S13, the Fd channel value estimation unit 31 calculates a channel estimation value PE21 (FIG. 6B) corresponding to a subcarrier bandwidth in which this subcarrier signal PLT2 is allocated.

Next, when the pilot signal is not allocated in the subcarrier bandwidth in some symbol, the Fd channel value estimation unit 31 calculates a channel estimation value corresponding to the subcarrier bandwidth with the following interpolation processing.

In other words, the Fd channel value estimation unit 31 interpolates the channel estimation value corresponding to the subcarrier bandwidth (hereinafter expressed as a subcarrier bandwidth X) in which the pilot signal is not allocated in some symbol (hereinafter, expressed as a symbol X) based on the channel estimation value corresponding to the subcarrier bandwidth X in the two symbols which are temporally before and after the symbol X.

In FIG. 6B, the portion illustrated by reference numeral PC1 in the symbol S12 is the subcarrier bandwidth (see the data signal DT1 in FIG. 6A) in which not the pilot signal but the data signal is allocated. In this case, the Fd channel value estimation unit 31 interpolates a channel estimation value corresponding to the subcarrier bandwidth X in which the pilot signal in the symbol X is not allocated based on the channel estimation values PE1, PE2 (see, FIG. 6B) corresponding to the subcarrier bandwidth X in the two symbols S11 and S13 which are temporary before and after the symbol X. This interpolated channel estimation value is illustrated by reference number PC1 in FIG. 6B. The subcarrier bandwidth illustrated by the vertical line hatching illustrates the interpolated channel estimation value.

The Fd channel value estimation unit 31 executes extraction of the pilot signal described in FIG. 6A, calculation of the channel estimation described in FIG. 6B, and interpolation for each of the predetermined number of symbols. The predetermined number of symbols is, for example, 4 symbols or 10 symbols.

Next, the Fd channel value estimation unit 31 determines the above-described predetermined number of symbols as FFT target symbols. Then, as illustrated in FIG. 6C, the Fd channel value estimation unit 31 executes FFT processing on the channel estimation value (including interpolated channel estimation value) in the predetermined number of symbols in the time direction (see vertical arrow in FIGS. 6A to 6C) in the subcarrier bandwidth in which the pilot signal is allocated. With this FFT processing, a variation amount of the channel estimation value per unit time is obtained. The time corresponding to the predetermined number (see vertical arrow in FIGS. 6A to 6C) is an example of the unit time. Here, this FFT processing is also referred to as two dimensional FFT.

The Fd channel value estimation unit 31 outputs the result in which FFT is performed on the channel estimation value like Ex(n,f), Ey(n,f), for example. Here, the channel estimation value has two values of I(In-phase)ch and Q(Quadrature-phase)ch. Accordingly, the result in which FFT is performed on the channel estimation has also two values corresponding to these Ich and Qch, in other words, Ex(n,f) and Ey(n,f).

Here, n indicates a position (pilot subcarrier) of the pilot signal allocated in the first symbol and 0˜(Np-1). Here, Np is the maximum number of pilot signals in one symbol. In the example of FIG. 6C, the position of the pilot subcarrier is the position illustrated by the arrow in FIG. 6C. The frequency is expressed by f and is 0˜(Nx-1). Nx indicates the number of symbols (for example, four) to be FFT targets.

The Fd estimation unit 32 executes following Formula 12, and calculates a change of E²(n,f) when the frequency f is changed.

E²(n,f)=(Ex(n,f))²+(Ey(n,f))² (Formula 12)

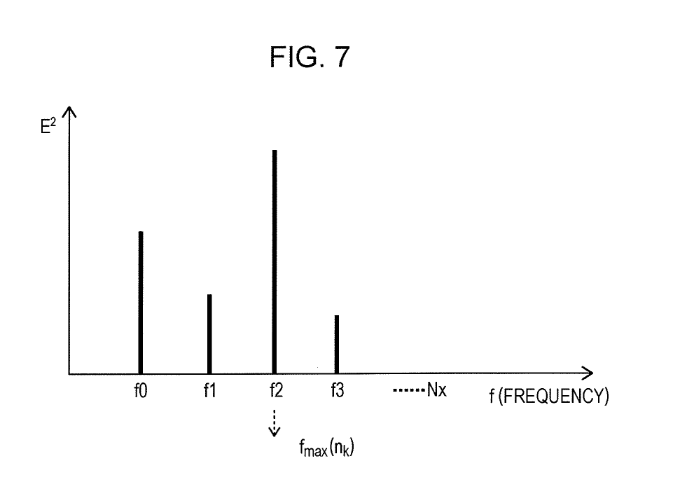

FIG. 7 is a diagram schematically illustrating a change of E²(n,f) in some pilot subcarrier nₖ. This pilot subcarrier nₖ is any one of subcarrier bandwidths illustrated by 8 arrows in the example of FIG. 6C.

In FIG. 7, the vertical axis is E²(n,f)(in the figure, it is expressed by E²) and the horizontal axis is the frequency f. Here, the Fd estimation unit 32 calculates the frequency f whose E²(n,f) becomes the largest in the pilot subcarrier n as the maximum frequency fmax(nₖ). In the example of FIG. 7, the frequency whose E²n,f) becomes the largest is f2.

Here, the maximum frequency fmax(n) is used as a weighting of E²(n,f) and is calculated like following Formula 13.

$${f}_{max} ( n ) = \frac{{\sum }_{f = 0}^{Nf} {E}^{2} ( n , f ) \times f}{{\sum }_{f = 0}^{Nf} {E}^{2} ( n , f )} \qquad ( Formula 13 )$$

As described above, the Fd estimation unit 32 changes n to calculate E²(n,f) described in FIG. 7 for each n.

The Fd estimation unit 32 calculates the Fd estimation value by following Formula.

$$Fd estimation value = \frac{1}{N p} {\sum }_{n = 0}^{N p} {f}_{ma x} ( n )$$

Then, the Fd estimation unit 32 determines the number of the channel estimation values to be averaging targets which is predetermined according to the size of the Fd estimation value. The Fd estimation value 32 outputs the determined number to the channel estimation value averaging unit 16.

(Other Calculation of Fd Estimation Value)

Besides, an Fd estimation value may be calculated by using various methods. For example, the Fd channel value estimation unit 31 may obtain a delay profile (in other words, a channel estimation value) for each symbol based on a digital signal in the frequency domain which is outputted from the first FFT unit 14 by using a conventional method.

In addition, the Fd channel value estimation unit 31 may calculate an Fd estimation value based on the delay profile for each of the symbols which are outputted by the first CS processing unit 15a to the fourth CS processing unit 15d. Here, when the channel estimation value for each of the symbols which are outputted by the first CS processing unit 15a to the fourth CS processing unit 15d is used, the first FFT unit 14 does not output the digital signal in the frequency domain to the Fd channel value estimation unit 31.

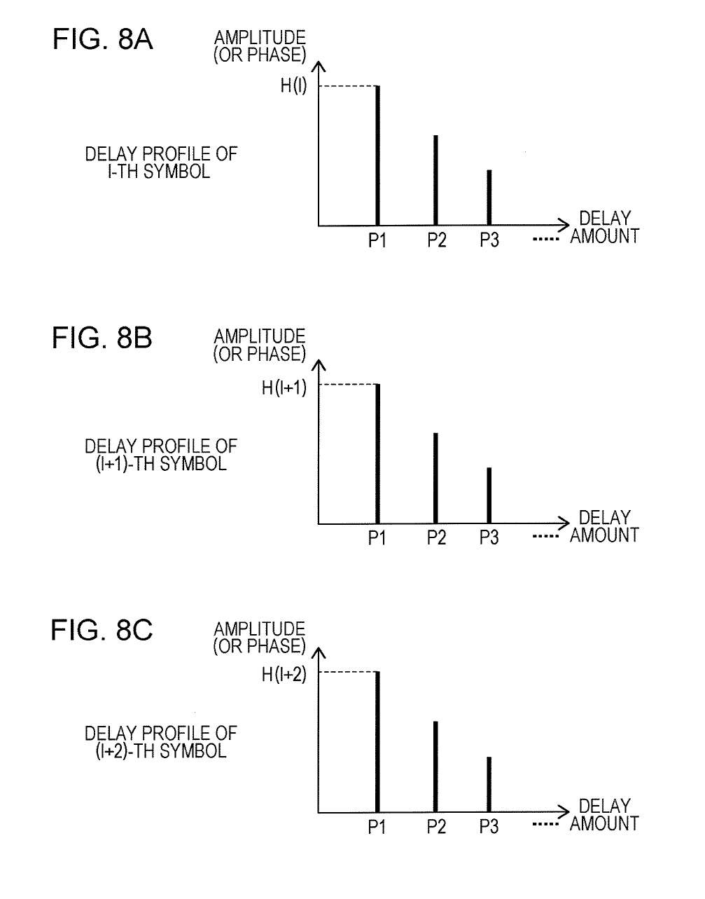

FIGS. 8A to 8C are graphs, each illustrating processing of calculating an Fd estimation value based on the delay profile. The horizontal axis is a delay amount (time) and the vertical axis is power (amplitude) of an impulse response. In FIG. 8, the power of the impulse response of the dominant wave exists in the position where the delay amount (delay time) is 0. Here, the vertical axis may indicate a phase.

FIG. 8A is a graph illustrating the delay profile of the l-th symbol which is calculated based on the channel estimation value of the l-th symbol. FIG. 8B is a graph illustrating the delay profile of the (l+1)th symbol which is calculated based on the channel estimation value of the (l+1)th symbol after the l-th symbol. FIG. 8C is a graph illustrating the delay profile of the (l+2)th symbol which is calculated based on the channel estimation value of the (l+2)th symbol after the (l+1)the symbol. It is to be noted, for example, that the first CS processing unit 15a calculates the channel estimation value of the l-th symbol, the second CS processing unit 15b calculates the channel estimation value of the (l+1) symbol, and the third CS processing unit 15c calculates the channel estimation value of the (l+2)th symbol.

The vertical lines (power components) in the delay amounts P1 to P3 schematically illustrate power of the channels (delay paths).

The Fd channel value estimation unit 31 integrates the changes in the power of the delay paths in two sequential symbols and calculates an average value of the integration to calculate an Fd estimation value. As the average value is larger, the Fd estimate value becomes lager.

For example, it is assumed that the maximum powers in the l-th symbol, the (l+1)th symbol, and the (l+2)symbol are respectively Hp(l), Hp(l+1), and Hp(l+2). The maximum power is the power in the delay amount P1.

The Fd channel value estimation unit 31 calculates a first difference between the power Hp(l) in the l-th symbol and the power Hp(l+1) in the (l+1)th symbol and a second difference between the power Hp(l+1) in the (l+1)th symbol and the power Hp(l+2)th in the (l+2)th symbol. Then, the Fd channel value estimation unit 31 calculates an average value of these first and second differences. After that, the Fd channel value estimation unit 31 outputs the calculated average value as the Fd estimation value to the Fd estimation unit 32.

Here, not only this maximum power but the changes in power at the delay amounts P2 and P3 are integrated and an average value of the integration may be calculated.

The present embodiment may determine the number of the channel estimation values suitable for the change state of the channel. As a result, when the change state of the channel is large, a difference between the average channel estimation value and the correct channel estimation value becomes larger. Consequently, the deterioration of the accuracy in the ICI replica may be suppressed.

### Third Embodiment

In the first and second embodiments, the l₁ recovery method of the CS processing is used to create a channel estimation value in a time domain. However, when a channel estimation value is calculated using the l₁ recovery method, the operation amount thereof is large. For this reason, to reduce the operation amount of the channel estimation value, an orthogonal matching pursuit (OMP) is used to calculate a channel estimation value. For example, the OMP method is disclosed in “J. A. Tropp, and A. C. Gilbert, “Signal Recovery From Random Measurements Via Orthogonal Matching Pursuit,” IEEE Transactions on Information Theory, vol. 53, no. 12, pp. 4655-4666, December 2007”.

In the OMP method, expected values of observation vectors corresponding to pulses are prepared in advance and calculates a distance between the expected value and the observation vector. Then, it is determined that the pulse corresponding to the expected value whose distance is the shortest exists.

After that, a component equivalent to the corresponding pulse is cancelled from the observation vector and the distance calculation is repeated again. A vector having sparsity may be also estimated by this method.

A receiver described in the third embodiment uses the OMP method to estimate an impulse response of a multipath channel.

(Block Diagram of the Receiver According to the Third Embodiment)

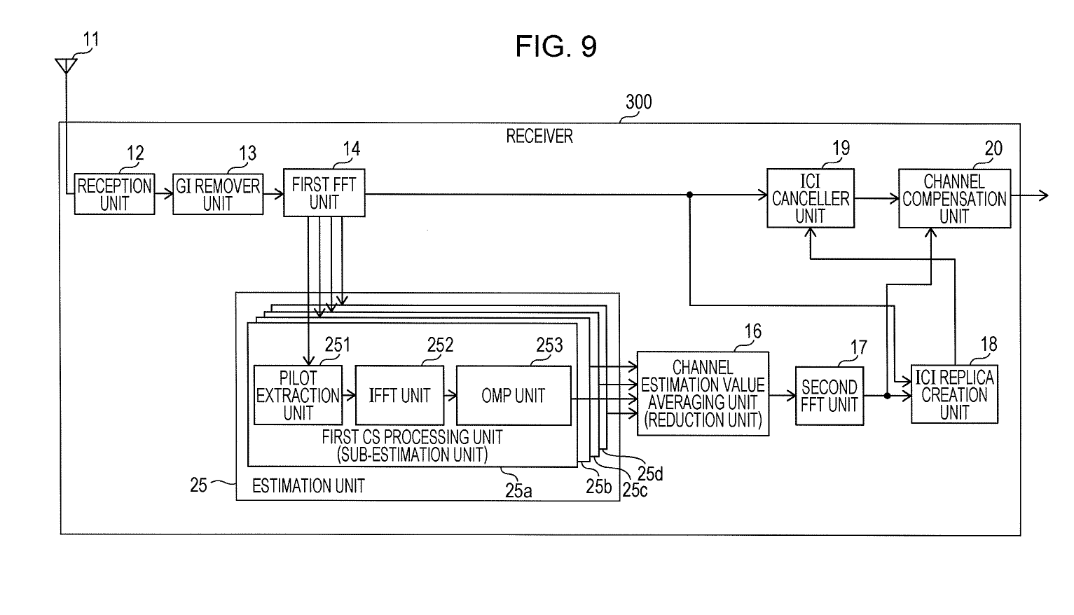

FIG. 9 is an example block diagram illustrating the hardware configuration of a receiver according to the third embodiment.

A receiver 300 is such that the estimation unit 15 in the receiver described in the first embodiment is replaced by an estimation unit 25. Here, the receiver 300 may have the configuration in which the measuring unit 30 described in the second embodiment is added, in other words, may have the configuration in which the function described in the second embodiment is added to the receiver in the third embodiment.

Each of a first CS processing unit 25a to a fourth CS processing unit 25d has a pilot extraction unit 251, an IFFT unit 252, and an OMP unit 253. In other words, each of the first CS processing unit 25a to the fourth CS processing unit 25d has a similar configuration.

The pilot extraction unit 251 extracts a pilot signal of a symbol including a pilot signal and a data signal from a distal signal in a frequency domain which is outputted from the first FFT unit 14. Specifically, the pilot extraction unit 251 extracts a pilot signal from a digital signal on which FFT processing is executed for each symbol and outputs the extracted pilot signal to the IFFT unit 252.

The IFFT unit 252 executes inverse fast Fourier transform processing and converts the pilot signal in the frequency domain to the pilot signal. The inverse fast Fourier transform is adequately expressed as IFFT (Inverse Fast Fourier Transform).

The OMP unit 253 executes the OMP method which is decoding algorism of a compressed sensing to estimate a channel impulse response from the pilot signal in the time domain. In other words, the OMP unit 253 executes the OMP method on the pilot signal in the time domain to calculate channel estimation value.

The OMP method is firstly described by using Formula 14 to Formula 31 before describing specific examples of the OMP method by referring to FIGS. 10 to 12.

It is assumed now that an observation vector y is expressed by following Formula 14. For example, this observation vector is equivalent to a signal in a time domain which is obtained in such a manner that the pilot signal extraction unit 251 extracts a pilot signal from a signal in a frequency domain, which is obtained by executing FFT on a signal in a time domain for one symbol received from a transmitter, and the IFFT unit 252 further executes IFFT on the extracted pilot signal.

y=Xg+z (Formula 14)

Here, it is assumed that the observation vector y is following Formula 15.

$$y = ( \begin{matrix}{y}_{1} \\ ⋮ \\ {y}_{n} \\ ⋮ \\ {y}_{N}\end{matrix} ) \qquad ( Formula 15 )$$

In Formula 15, y is an N (N is 1 or larger integer) dimensional observation vector. This N is equivalent to the number of OFDM carriers. In the case of the receiver to receive signals for terrestrial digital broadcasting, N is 8192, for example.

Hereinafter, g is a K (K is 1 or larger integer) dimensional impulse response vector and is expressed by following Formula 16.

$$g = ( \begin{matrix}{g}_{1} \\ ⋮ \\ {g}_{k} \\ ⋮ \\ {g}_{K}\end{matrix} ) \qquad ( Formula 16 )$$

where K is time (for example, a sampling time) 1 . . . k (a small letter) . . . K (a large letter) indicates a temporal change. In other words, the above equation is K dimensional impulse response vector indicating a temporal position of the impulse response.

The impulse response g has sparsity. Almost all the elements of the impulse response g are 0 except the several elements including pulses.

Furthermore, z is a vector indicating noise and is expressed by following Formula 17.

$$z = ( \begin{matrix}{z}_{1} \\ ⋮ \\ {z}_{n} \\ ⋮ \\ {z}_{N}\end{matrix} ) \qquad ( Formula 17 )$$

Furthermore, Formula 18 is a matrix expressing transform between a sparse vector and an observation vector.

$$X = ( \begin{matrix}{x}_{11} & … & {x}_{1 k} & … & {x}_{1 K} \\ ⋮ & & ⋮ & & ⋮ \\ {x}_{n 1} & … & {x}_{nk} & … & {x}_{nK} \\ ⋮ & & ⋮ & & ⋮ \\ {x}_{N 1} & … & {x}_{Nk} & … & {x}_{NK}\end{matrix} ) = ( \begin{matrix}{x}_{1} & … & {x}_{k} & … & {x}_{K}\end{matrix} ) \qquad ( Formula 18 )$$

More specifically, Formula 18 is a matrix with N row and K column (a first matrix) expressing the transform between the N dimensional observation vector and the K dimensional impulse response vector g.

This matrix is also referred to as sensing matrix X and is a predetermined matrix.

Here, following Formula 19 expresses a vector including the k-th column of the sensing matrix X.

$${x}_{k} = ( \begin{matrix}{x}_{1 k} \\ ⋮ \\ {x}_{nk} \\ ⋮ \\ {x}_{Nk}\end{matrix} ) \qquad ( Formula 19 )$$

And now, in the OMP method executed by the IFFT unit 252, the impulse response g is obtained from the observed vector y. Firstly, the OMP unit 253 substitutes the observation vector y for a remaining vector as expressed by following Formula 20.

r₀=y (Formula 20)

Here, rₜ is a remaining vector after t times searches. In the following calculation, only the column corresponding to the position of non-zero element of the sparse vector is extracted from the sensing matrix X to create a new matrix. Hereinafter, the new matrix is referred to as a sensing matrix (a second matrix) as appropriate.

The OMP unit 253 defines an initial value of the matrix for creating the new matrix by following Formula 21.

X₀=O (Formula 21)

The initial matrix is a zero matrix having no element. The OMP unit 253 starts repeating the OMP method from here. Firstly, the OMP unit 253 updates a loop counter t as expressed by following Formula 22.

t←t+1 (Formula 22)

Next, the OMP unit 253 searches following Formula 23 by a column vector closest to the remaining vector.

$${λ}_{t} = arg {max}_{k ∈ S} \vert 〈 {r}_{t - 1} , {x}_{k} 〉 \vert \qquad ( Formula 23 )$$

Here, <x,y> is an inner product of vectors x and y. With above Formula, k which makes the inner product <rₜ₋₁,Xₖ> maximum is calculated and the calculated k is substituted for λₜ and S is a set of numbers excluding the already selected λₜ from the integers 1 to K. In other words, S may be expressed by following Formula 24.

S={1, 2, . . . , K}−{λ₁, . . . , λₜ} (Formula 24)

Next, the OMP unit 253 creates a new tentative sensing matrix (following Formula 25) by coupling the λₜ-th column X_{λ}_{ₜ} in the sensing matrix X onto the right side of the tentative sensing matrix Xₜ₋₁.

Xₜ=(Xₜ₋x_{λ}_{ₜ}) (Formula 25)

Next, the OMP unit 253 executes an operation expressed by following Formula 26.

$${\hat{h}}_{t} = arg {min}_{h} {‖ {r}_{t - 1} - {X}_{t} h ‖}^{2} = {X}_{t}^{+} {r}_{t - 1} \qquad ( Formula 26 )$$

The OMP unit 253 calculates h which makes ∥rₜ₋₁Xth∥² minimum by above Formula. In Formula 26, Xₜh is a tentative estimation value of an impulse response.

Following Formula 27 expressed in Formula 26 is a t dimensional column vector which is formed of element values selected by the sparse vector.

$$h = ( \begin{matrix}{h}_{1} \\ ⋮ \\ {h}_{t}\end{matrix} ) \qquad ( Formula 27 )$$

Following Formula 28 expressed in Formula 26 is an estimation value of the t dimensional column vector h.

$${\hat{h}}_{t} = ( \begin{matrix}{\hat{h}}_{1} \\ ⋮ \\ {\hat{h}}_{t}\end{matrix} ) \qquad ( Formula 28 )$$

The matrix Xₜ⁺ is a pseudo-inverse matrix of the tentative sensing matrix Xₜ. The OMP unit 253 uses the estimation value to update the remaining vector as expressed by following Formula 29. The h corresponds to the impulse response g. Here, the reason why h, not g, is used is that a degree of g is K but a degree of h is t. The t is a loop counter.

rₜ=rₜ₋₁−Xₜĥₜ (Formula 29)

This remaining vector is an excluded N dimensional signal vector in which the already estimated tentative impulse response vector is excluded from the N dimensional signal vector (observation vector y).

The OMP unit 253 repeats the processing from the loop counter update to the remaining vector update until the size of the remaining vector becomes smaller than a threshold set in advance and following Formula 30 is fulfilled (ε is a preset threshold) or the loop counter (repeating number) t reaches K, in other words, t=K holds.

∥rₜ∥²<ε (Formula 30)

Here, the left side of Formula 30 expresses a square distance. Lastly, the OMP unit 253 calculates a channel estimation value indicating an estimation result of an impulse response which is a sparse vector by following Formula 31.

ĝ=(e_{λ}_{ₜ}, e_{λ}_{ₖ}, . . . , e_{λ}_{ₜ})ĥₜ (Formula 31)

Here, e_{k′} is a vector with the k′-tj element of 1 and other elements of 0.

The OMP unit 253 executes the above-described OMP method as follows. In other words, the OMP 253 executes first processing to be described later and then repeatedly executes second processing to be described later.

The OMP unit 253 executes the following processing as the first processing. In other words, the OMP unit 253 calculates a column number of the sensing matrix X, whose inner product of the N dimensional signal vector (observation vector y) and the column component of the sensing matrix X (first matrix) becomes maximum. The OMP unit 253 creates a tentative sensing matrix (second matrix) by coupling a column vector in this column number in the sensing matrix X to the right side of the zero matrix and estimates a tentative impulse response vector based on the second matrix and the N dimensional signal vector.

The OMP unit 253 executes following processing as the second processing. In other words, the OMP unit 253 calculates a column number of the sensing matrix X whose inner product of the excluded N dimensional signal vector, in which the already estimated tentative impulse response is excluded from the N dimensional signal vector, and the column component of the sensing matrix X.

The OMP unit 253 creates a new second matrix by coupling a column vector in the column number in the sensing matrix X to the right side of the tentative sensing matrix and estimates a tentative impulse response vector based on the new tentative sensing matrix and the N dimensional signal vector.

The OMP unit 253 stops repeating the second processing when the number of times of executing the first and second processing reaches K or the excluded N dimensional signal vector comes to have a predetermined size or larger. Then, the OMP unit 253 calculates a channel estimation value indicating an estimation result of the impulse response based on the calculated column number and the estimated tentative impulse response vector.

(Specific Examples of the OMP Method)

Next, referring to FIGS. 10 to 12, specific examples of the OMP method are described. FIG. 10 is a graph illustrating delay profiles. The horizontal axis is time and the vertical axis power of an impulse response. In FIG. 10, the power of a noise component is also illustrated.

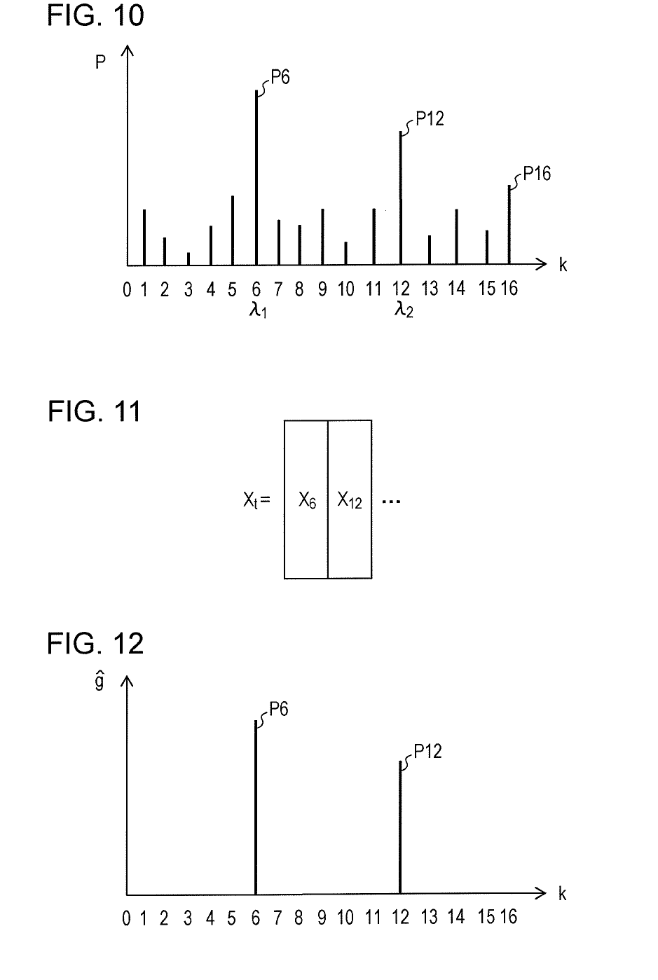

FIG. 11 is a diagram schematically illustrating the tentative sensing matrix Xₜ. FIG. 12 is a graph is a diagram illustrating the delay profiles which are obtained by executing the OMP method on the power component illustrated in FIG. 10. Here, in the graphs of FIGS. 10 and 12, the power of an impulse response of a dominant wave exists in the position where k(time) is 0.

Here, in FIG. 10, at each power when k is 1 to 16, the largest power is power (reference numeral P6) at the time point when k is 6, and the second largest power is power (reference numeral P12) at the time point when k is 12.

Then, it is assumed that there are two channels for delay waves and power at 6 in k and power at 12 in k correspond power of impulse responses of the delay waves. Here, the third largest power is power (reference numeral P16) at the time point when k is 16.

Firstly, the OMP unit 253 substitutes 0 for t into Formula 22 expressing a loop counter in the state where Formulas 14 to 21 are defined and obtains t=1.

In Formula 23, Formula into which t=1 is substituted as following Formula 32.

$${λ}_{1} = arg {max}_{k ∈ S} \vert 〈 {r}_{0} , {x}_{k} 〉 \vert \qquad ( Formula 32 )$$

The OMP unit 253 calculates k which makes λ₁ maximum in Formula 32. In the example of FIG. 10, the largest power is power (see reference numeral P6) when k=6. Accordingly, when k=6, the inner product of Formula 32 becomes the largest. As a result, a numerical value corresponding to the element number λ₁ becomes 6.

Formula 33 in which t=1 and λ₁=6 are substituted into Formula 25 is as follows.

X₁=(X₀X₆) (Formula 33)

The portion X₆ in FIG. 11 schematically illustrates the contents of Formula 33.

Formula in which t=1 is substituted into Formula 26 is expressed as following Formula 34.

$${\hat{h}}_{1} = arg {min}_{k} {‖ {r}_{0} - {X}_{1} h ‖}^{2} = {X}_{1}^{+} {r}_{0} \qquad ( Formula 34 )$$

Next, the OMP unit 253 calculates a remaining vector r₁ expressed in following Formula 35 by Formula 29.

r₁=r₀−X₁ĥ₁ (Formula 35)

It is assumed here that the size of the remaining vector r₁ does not become less than a preset threshold (see Formula 30) yet, and t=K is not satisfied. Accordingly, the OMP unit 253 substitutes 1 for t on the right side of Formula 22 expressing an increment of the loop counter t and t=2 is obtained.

An equation in which t=2 is substituted into Formula 23 is expressed as following Formula 36.

$${λ}_{2} = arg {max}_{k ∈ S} \vert 〈 {r}_{1} , {x}_{k} 〉 \vert \qquad ( Formula 36 )$$

The OMP unit 253 calculates k which makes λ₂ maximum in the above equation. In the example of FIG. 10, the second largest power is power (reference numeral P12) when k=12. Accordingly, when k=12, the inner product of the above equation becomes maximum. As a result, a numerical value corresponding to the element number λ₂ becomes 12.

An equation in which t=2 and the element number λ₂=12 are substituted into Formula 25 is expressed as following Formula 37.

X₂=(X₁X₁₂) (Formula 37)

The portion X₆X₁₂ in FIG. 11 schematically illustrates the contents of Formula 37.

An equation in which t=2 is substituted into Formula 26 is expressed as following Formula 38.

$${\hat{h}}_{2} = arg {min}_{h} {‖ {r}_{1} - {X}_{2} h ‖}^{2} = {X}_{2}^{+} {r}_{1} \qquad ( Formula 38 )$$

Hereinafter, the OMP unit 253 calculates the remaining vector r₂ expressed by following Formula 39 by Formula 29.

r₂=r₁−X₂ĥ₂ (Formula 39)

It is assumed here that the size of the remaining vector r₂ becomes less than a preset threshold (see Formula 30). Accordingly, the portion of (eλ₁, eλ₂, . . . , eλₜ) in Formula 31 becomes (e₆, e₁₂). Here, the vector e is a vector whose maximum element number is K, for example, and in the examples of FIGS. 10 and 12, K is 16.

Here, when e₆, only the sixth element is 1, [0,0,0,0,0,1,0,0,0,0,0,0,0,0,0,0]̂T. Here, T indicates a transposed matrix.

And, when e₁₂, only the twelfth element is 1, [0,0,0,0,0,0,0,0,0,0,0,1,0,0,0,0]̂T.

Accordingly, the matrix in the portion of (eλ₁, eλ₂, . . . , eλₜ) in Formula 31 becomes a matrix of the 16 by 2 matrix.

$$( \begin{matrix}0 & 0 \\ 0 & 0 \\ 0 & 0 \\ 0 & 0 \\ 0 & 0 \\ 1 & 0 \\ 0 & 0 \\ 0 & 0 \\ 0 & 0 \\ 0 & 0 \\ 0 & 0 \\ 0 & 1 \\ 0 & 0 \\ 0 & 0 \\ 0 & 0 \\ 0 & 0\end{matrix} ) \qquad ( Formula 40 )$$

As illustrated in FIG. 12, with the above processing, the OMP unit 253 estimates that the impulse responses of the two delay waves (see reference numerals P6 and P12) are in temporal positions where k=6 and k=12.

As described above, the OMP 253 calculates a channel estimation value in the l-th symbol and outputs it to the channel estimation value averaging unit 16. Here, the processing executed by the channel estimation value averaging unit 16 is described in detail in the first embodiment, and the description thereof is omitted.

The receiver according to the third embodiment utilizes the OMP method. Accordingly, as compared with the case where the l1 recovery method of the CS processing is used, an operation amount of the channel estimation value may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A receiver comprising:
an extraction unit configured to extract a pilot signal of a received symbol including the pilot signal and a data signal, the symbol being one of sequential symbols received by the receiver;
an estimation unit configured to calculate a channel estimation value indicating an estimation result of a channel impulse response in the symbol, based on the pilot signal by executing a decoding algorithm of compressed sensing;
a reduction unit configured to perform a predetermined operation on each of channel estimation values of symbols of a predetermined number among the symbols, the operation reducing an error component included in the channel estimation value; and
a canceller unit configured to cancel an inter-carrier interference component included in any one of symbols of the predetermined number, based on the channel estimation value in which the error component is reduced.

2. The receiver according to claim 1, further comprising:
a plurality of estimation units, each configured to calculate the channel estimation value of the sequential symbols, respectively.

3. The receiver according to claim 1,
wherein the predetermined operation is an operation of averaging each of the channel estimation values of symbols of the predetermined number.

4. The receiver according to claim 3,
wherein the predetermined operation is an operation of calculating a total sum of the channel estimation values of symbols of the predetermined number including a first symbol of symbols of the predetermined number, one or more second symbols temporal positioned before the first symbol, and one or more third symbols temporal positioned after the first symbol, and dividing the total sum by the predetermined number, so that an averaged channel estimation value is calculated, and
wherein the canceller unit cancels an inter-carrier interference component included in the data signal of the first symbol, based on the averaged channel estimation value.

5. The receiver according to claim 1, further comprising:
a measuring unit configured to measure a variation of a channel,
wherein the reduction unit makes the predetermined number smaller as a variation amount of the channel becomes larger.

6. The receiver according to claim 5,
wherein the measuring unit calculates a channel estimation value indicating an estimation result of the channel in each of the sequential symbols, based on the pilot signal of each of the sequential symbols, and measures a variation amount per unit time of the calculated channel estimation value in each of the sequential symbols as the variation amount of the channel.

7. The receiver according to claim 1,
wherein the decoding algorithm of compressed sensing is a basis pursuit method,
wherein it is provided that a product of a transformation matrix with an N row and an M column and an M dimensional vector of transmission signal transmitted from a transmitter is equal to a vector of N dimensional reception signal corresponding to the pilot signal,
wherein the estimation unit calculates an estimation vector which minimizes an L1 norm of the vector of transmission signal, and calculates the channel estimation value of the symbol, based on column components of the transformation matrix calculated in a process of calculating the estimation vector, and
wherein N is 1 or a larger integer and M is 1 or a larger integer.

8. The receiver according to claim 1,
wherein the pilot signal is an N dimensional signal vector in a time domain,
wherein the decoding algorithm of compressed sensing is an orthogonal matching pursuit (OMP) method,
wherein the estimation unit has a first matrix with an N row and a K column expressing transformation between the N dimensional signal vector and K dimensional impulse response vector indicating a temporal position of the impulse response, and executes the OMP method including:
performing first processing to calculate a column number of the first matrix that provides a maximum inner product of the N dimensional signal vector and the column component of the first matrix becomes maximum, create a second matrix by coupling a column vector of the column number in the first matrix to the right side of a zero matrix, and estimate a tentative impulse response vector based on the second matrix and the N dimensional signal vector;
repeatedly performing second processing to calculate a column number of the first matrix that provides a maximum inner product of an excluded N dimensional signal vector, which is obtained by excluding the already estimated tentative impulse response from the N dimensional signal vector, and the column component of the first matrix, create a new second matrix by coupling a column vector of the column number in the first matrix to the right side of the second matrix, and estimate a tentative impulse response vector based on the new second matrix and the excluded N dimensional signal vector; and
calculating the channel estimation value indicating the estimation result of the impulse response based on the calculated column numbers and the estimated tentative impulse response vectors, and
wherein N is 1 or a larger integer and K is 1 or a larger integer.

9. The receiver according to claim 8,
wherein the estimation unit stops repeating the second processing when the number of execution times of the first and second processing reaches the K or a size of the excluded N dimensional signal vector becomes a predetermined size or larger.

10. A receiving method comprising:
receiving a symbol including a pilot signal and a data signal, the symbol being one of sequential received symbols;
extracting the pilot signal from the received symbol,
calculating a channel estimation value indicating an estimation result of a channel impulse response in the symbol, based on the pilot signal by executing a decoding algorithm of compressed sensing;
performing a predetermined operation on each of channel estimation values of symbols of a predetermined number of the symbols so as to reduce an error component included in the channel estimation value, and
canceling an inter-carrier interference component included in any one of symbols of the predetermined number, based on the channel estimation value in which the error component is reduced.
